(19) United States
(12) Patent Application Publication
(10) Pub. No.: US 2022/0138409 A1
(43) Pub. Date: May 5, 2022

(54) APPARATUS, SYSTEM, AND METHOD FOR AUTOMATING DOCUMENT DRAFTING

(71) Applicant: Rowan TELS Corp., Seattle, WA (US)

(72) Inventors: Benjamin Demboski, Seattle, WA (US); Mark Charyk, Seattle, WA (US); David Billmaier, Woodinville, WA (US)

(73) Assignee: Rowan TELS Corp., Seattle, WA (US)

(21) Appl. No.: 17/089,400

(22) Filed: Nov. 4, 2020

(51) Int. Cl. G06F 40/169; G06F 40/279

(52) U.S. Cl. CPC G06F 40/169; G06F 40/279

(57) ABSTRACT

A system and method for automated document drafting is disclosed. The method comprises searching text in a document for a term, determining an insertion point for a definition associated with the term, and combining the definition with the text at the insertion point. The term may be a specific term type within a specialized document like a claim term in a patent document. The text structure of the definition for a term may vary from a single sentence without line breaks to a block-level element with multiple paragraphs or lists. The insertion point may vary according to the contextual needs of the definition placement. An inline definition may be next to, or even replace, the term it defines while a block-level element definition may be placed at the end of a document.

### BACKGROUND

The insertion of supporting text into documents of various kinds has proven a challenge for even the most sophisticated word processing applications (and previously, page layout and publishing services). Footnotes, end notes, bibliographical references, appendices, and similar formats have supported scholarly books, papers, articles, patent applications, and similar written and printed material for centuries. In the era of electronic document creation new methods of referencing material have become feasible (e.g., embedded hypertext links, rollover sidebars and definitions). Yet the age-old difficulty of effectively placing supplementary terms in a written work remains, not least because the format of the above-mentioned materials has changed very little over time. Meanwhile, the electronic means of supporting terms with references have greatly expanded.

When determining where and how to place references or supporting text, publishers or authors face a consistent challenge of optimal location, e.g., where a supporting note, reference, quote, definition, or similar text should be placed for clear, consistent, and convenient use by a reader. In many documents and articles, notes and bibliographical references appear as footnotes (e.g., at the bottom of the page on which their referring text appears), while the often less-structured notes append to the end. In patent documents definitions may be collected into a glossary or interspersed into the text in which the terms appear. Books tend to follow a similar “footnoting on the page, notes in the back” format as articles, but may vary based on the book length, academic pretension, number of footnotes and notes, or other factors. Without a clear, consistent format for placing reference or supporting text in written material, readers may be forgiven for not searching for this material—or even for missing it altogether.

Supporting reader usage of reference and similar text also faces a challenge at the creation stage of a document, article, book, or the like. For example, even though a term or text passage may appear multiple times in a written work, an accompanying definition, note or similar reference appears only once—typically at its first occurrence. While this format assists the reader, the tracking of a first occurrence (or second, third, and so on) presents a serious publishing problem, e.g., when occurrences are reshuffled when a work is edited. For additional creation complexity, a work may include nested references, i.e., definitions or references occurring inside other definitions or references. The combination of nested and first occurrence tracking of supporting text creates even greater complexity.

Therefore, there is a need for a system and method for document drafting in which text, formatted in a variety of ways, may be flexibly inserted into a written work for optimal usage.

### BRIEF SUMMARY

The disclosure describes an apparatus, system, and method for automating document drafting. In one embodiment, a method is disclosed, comprising searching text for a term, determining an insertion point for a definition associated with the term, and combining the definition with the text at the insertion point. In another embodiment, a computing apparatus is disclosed, the computing apparatus comprising a processor and a memory storing instructions that, when executed by the processor, configure the apparatus to scan one or more ordered sections of a patent document for a term, determine an insertion point for a definition associated with the term, and insert the definition into the patent document at the insertion point.

In yet another embodiment, a non-transitory computer-readable storage medium is disclosed. The computer-readable storage medium includes instructions that when executed by a computer, cause the computer to first determine a document object model (DOM) for a patent document. The computer then determines a term set. Each term of this term set comprises an associated definition. Next the computer searches predetermined sections of the DOM for a term in the term set. Finally, when a term in the term set matches a term in the text of the predetermined sections, the computer merges a definition into the text of that predetermined section.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is an example block diagram of a computing device 100 that may be used in one embodiment.

FIG. 2 illustrates a client server network configuration 200 in accordance with one embodiment.

FIG. 3 illustrates an example document 300 in accordance with one embodiment.

FIG. 4 illustrates an example document 400 in accordance with one embodiment.

FIG. 5 illustrates a listing of terms and definitions 500 in accordance with one embodiment.

FIG. 6 illustrates definitions and insertion points at different positions 600 in accordance with one embodiment.

FIG. 7 illustrates a document object model 700 in accordance with one embodiment.

FIG. 8 illustrates a block-level element insertion based on tagging identified text 800 in accordance with one embodiment.

FIG. 9 illustrates an inline text insertion based on tagging identified text 900 in accordance with one embodiment.

FIG. 10 illustrates a method for automatically inserting contextual definitions 1000 in accordance with one embodiment.

FIG. 11 illustrates a routine 1100 in accordance with one embodiment.

### DETAILED DESCRIPTION

An apparatus, system, and method for automating document drafting are disclosed. Automated document drafting refers to the process of using standard electronic page markup tools, such as HTML or XML, to insert or append supporting text or other media into a written body of work. Supporting text may include text associated with content (e.g., definitions or suggestions), footnotes, endnotes, references, and so forth. Supporting text may come in various forms, from simple sentences to complex ordered lists. Since many document types pay particular attention to the number of occurrences of terms (e.g., defining an acronym after its first use), automated document drafting also addresses term tracking. Tracking may include complexities such as occurrences of terms within definitions and tracking undefined terms. The structure of documents also affects drafting and text markup processes (e.g., many document types including patent documents), have a defined order and specification for how text and terms are presented, and automated drafting may retain both this structure and the means to insert supporting text within it.

Finally, an apparatus, system, and method for automating document drafting accommodates a general editing process of both documents and supporting text. The process may include, but not be limited to, text rearrangement, deletion, insertion, revision, and the various formatting means available through standard markup languages.

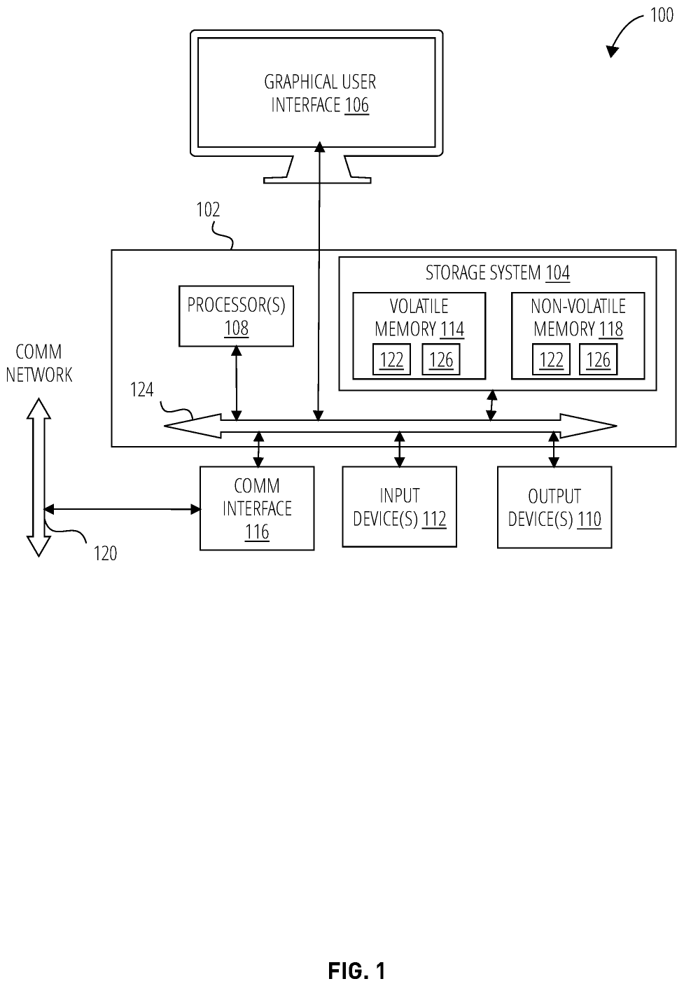

FIG. 1 is an example block diagram of a computing device 100 that may incorporate embodiments of the claimed solution. FIG. 1 is merely illustrative of a machine system to carry out aspects of the technical processes described herein, and does not limit the scope of the claims. One of ordinary skill in the art would recognize other variations, modifications, and alternatives. In certain embodiments, the computing device 100 includes a graphical user interface 106, a data processing system 102, a communication network 120, communication network interface 116, input device(s) 112, output device(s) 110, and the like.

As depicted in FIG. 1, the data processing system 102 may include one or more processor(s) 108 and a storage system 104. “Processor” refers to any circuitry, component, chip, die, package, or module configured to receive, interpret, decode, and execute machine instructions. Examples of a processor may include, but are not limited to, a central processing unit, a general-purpose processor, an application-specific processor, a graphics processing unit (GPU), a field programmable gate array (FPGA), Application Specific Integrated Circuit (ASIC), System on a Chip (SoC), virtual processor, processor core, and the like. The processor(s) 108 communicate with a number of peripheral devices via a bus subsystem 124. These peripheral devices may include input device(s) 112, output device(s) 110, communication network interface 116, and the storage system 104. The storage system 104, In one embodiment, comprises one or more storage devices and/or one or more memory devices. The term “storage device” refers to any hardware, system, sub-system, circuit, component, module, non-volatile memory media, hard disk drive, storage array, device, or apparatus configured, programmed, designed, or engineered to store data for a period of time and retain the data in the storage device while the storage device is not using power from a power supply. Examples of storage devices include, but are not limited to, a hard disk drive, FLASH memory, MRAM memory, a Solid-State storage device, Just a Bunch Of Disks (JBOD), Just a Bunch Of Flash (JBOF), an external hard disk, an internal hard disk, and the like.

In one embodiment, the storage system 104 includes a volatile memory 114 and a non-volatile memory 118. The term “volatile memory” refers to a shorthand name for volatile memory media. In certain embodiments, volatile memory refers to the volatile memory media and the logic, controllers, processor(s), state machine(s), and/or other periphery circuits that manage the volatile memory media and provide access to the volatile memory media. The term “non-volatile memory” refers to shorthand name for non-volatile memory media. In certain embodiments, non-volatile memory media refers to the non-volatile memory media and the logic, controllers, processor(s), state machine(s), and/or other periphery circuits that manage the non-volatile memory media and provide access to the non-volatile memory media. The volatile memory 114 and/or the non-volatile memory 118 may store computer-executable instructions 126 that alone or together form logic 122 that when applied to, and executed by, the processor(s) 108 implement embodiments of the processes disclosed herein. The term “logic” refers to machine memory circuits, non-transitory machine readable media, and/or circuitry which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

“Memory” refers to any hardware, circuit, component, module, logic, device, or apparatus configured, programmed, designed, arranged, or engineered to retain data. Certain types of memory require availability of a constant power source to store and retain the data. Other types of memory retain and/or store the data when a power source is unavailable.

“Volatile memory media” refers to any hardware, device, component, element, or circuit configured to maintain an alterable physical characteristic used to represent a binary value of zero or one for which the alterable physical characteristic reverts to a default state that no longer represents the binary value when a primary power source is removed or unless a primary power source is used to refresh the represented binary value. Examples of volatile memory media include but are not limited to dynamic random-access memory (DRAM), static random-access memory (SRAM), double data rate random-access memory (DDR RAM) or other random access solid state memory While the volatile memory media is referred to herein as “memory media,” in various embodiments, the volatile memory media may more generally be referred to as volatile memory. In certain embodiments, data stored in volatile memory media is addressable at a byte level which means that the data in the volatile memory media is organized into bytes (8 bits) of data that each have a unique address, such as a logical address.

“Computer” refers to any computing device. Examples of a computer include, but are not limited to, a personal computer, a laptop, a tablet, a desktop, a server, a main frame, a super computer, a computing node, a virtual computer, a hand held device, a smart phone, a cell phone, a system on a chip, a single chip computer, and the like.

“File” refers to a unitary package for storing, retrieving, and communicating data and/or instructions. A file is distinguished from other types of packaging by having associated management metadata utilized by the operating system to identify, characterize, and access the file.

“Module” refers to a computer code section having defined entry and exit points. Examples of modules are any software comprising an application program interface, drivers, libraries, functions, and subroutines.

“Hardware” refers to Logic embodied as analog and/or digital circuitry.

“Instructions” refers to symbols representing commands for execution by a device using a processor, microprocessor, controller, interpreter, or other programmable logic. Broadly, ‘instructions’ may mean source code, object code, and executable code. ‘instructions’ herein is also meant to include commands embodied in programmable read-only memories (EPROM) or hard coded into hardware (e.g., ‘micro-code’) and like implementations wherein the instructions are configured into a machine memory or other hardware component at manufacturing time of a device.

“Operating system” refers to logic, typically software, that supports a device's basic functions, such as scheduling tasks, managing files, executing applications, and interacting with peripheral devices. In normal parlance, an application is said to execute “above” the operating system, meaning that the operating system is necessary in order to load and execute the application and the application relies on modules of the operating system in most cases, not vice-versa. The operating system also typically intermediates between applications and drivers. Drivers are said to execute “below” the operating system because they intermediate between the operating system and hardware components or peripheral devices.

“Software” refers to logic implemented as processor-executable instructions in a machine memory (e.g. read/write volatile memory media or non-volatile memory media). “Application” refers to any software that is executed on a device above a level of the operating system. An application will typically be loaded by the operating system for execution and will make function calls to the operating system for lower-level services. An application often has a user interface but this is not always the case. Therefore, the term ‘application’ includes background processes that execute at a higher level than the operating system.

The input device(s) 112 include devices and mechanisms for inputting information to the data processing system 102. These may include a keyboard, a keypad, a touch screen incorporated into the graphical user interface 106, audio input devices such as voice recognition systems, microphones, and other types of input devices. In various embodiments, the input device(s) 112 may be embodied as a computer mouse, a trackball, a track pad, a joystick, wireless remote, drawing tablet, voice command system, eye tracking system, and the like. The input device(s) 112 typically allow a user to select objects, icons, control areas, text and the like that appear on the graphical user interface 106 via a command such as a click of a button or the like.

The output device(s) 110 include devices and mechanisms for outputting information from the data processing system 102. These may include the graphical user interface 106, speakers, printers, infrared LEDs, and so on, as well understood in the art. In certain embodiments, the graphical user interface 106 is coupled to the bus subsystem 124 directly by way of a wired connection. In other embodiments, the graphical user interface 106 couples to the data processing system 102 by way of the communication network interface 116. For example, the graphical user interface 106 may comprise a command line interface on a separate computing device 100 such as desktop, server, or mobile device.

The communication network interface 116 provides an interface to communication networks (e.g., communication network 120) and devices external to the data processing system 102. The communication network interface 116 may serve as an interface for receiving data from and transmitting data to other systems. Embodiments of the communication network interface 116 may include an Ethernet interface, a modem (telephone, satellite, cable, ISDN), (asynchronous) digital subscriber line (DSL), FireWire, USB, a wireless communication interface such as Bluetooth or WiFi, a near field communication wireless interface, a cellular interface, and the like.

The communication network interface 116 may be coupled to the communication network 120 via an antenna, a cable, or the like. In some embodiments, the communication network interface 116 may be physically integrated on a circuit board of the data processing system 102, or in some cases may be implemented in software or firmware, such as “soft modems”, or the like.

The computing device 100 may include logic that enables communications over a network using protocols such as HTTP, TCP/IP, RTP/RTSP, IPX, UDP and the like.

The volatile memory 114 and the non-volatile memory 118 are examples of tangible media configured to store computer readable data and instructions to implement various embodiments of the processes described herein. Other types of tangible media include removable memory (e.g., pluggable USB memory devices, mobile device SIM cards), optical storage media such as CD-ROMS, DVDs, semiconductor memories such as flash memories, non-transitory read-only-memories (ROMS), battery-backed volatile memories, networked storage devices, and the like. The volatile memory 114 and the non-volatile memory 118 may be configured to store the basic programming and data constructs that provide the functionality of the disclosed processes and other embodiments thereof that fall within the scope of the claimed solution.

Logic 122 that implements one or more parts of embodiments of the solution may be stored in the volatile memory 114 and/or the non-volatile memory 118. Logic 122 may be read from the volatile memory 114 and/or non-volatile memory 118 and executed by the processor(s) 108. The volatile memory 114 and the non-volatile memory 118 may also provide a repository for storing data used by the logic 122.

The volatile memory 114 and the non-volatile memory 118 may include a number of memories including a main random-access memory (RAM) for storage of instructions and data during program execution and a read only memory (ROM) in which read-only non-transitory instructions are stored. The volatile memory 114 and the non-volatile memory 118 may include a file storage subsystem providing persistent (non-volatile) storage for program and data files. The volatile memory 114 and the non-volatile memory 118 may include removable storage systems, such as removable flash memory.

The bus subsystem 124 provides a mechanism for enabling the various components and subsystems of data processing system 102 communicate with each other as intended. Although the communication network interface 116 is depicted schematically as a single bus, some embodiments of the bus subsystem 124 may utilize multiple distinct busses.

It will be readily apparent to one of ordinary skill in the art that the computing device 100 may be a device such as a smartphone, a desktop computer, a laptop computer, a rack- mounted computer system, a computer server, or a tablet computer device. As commonly known in the art, the computing device 100 may be implemented as a collection of multiple networked computing devices. Further, the computing device 100 will typically include operating system logic (not illustrated) the types and nature of which are well known in the art.

Terms used herein should be accorded their ordinary meaning in the relevant arts, or the meaning indicated by their use in context, but if an express definition is provided, that meaning controls.

The apparatuses, systems, and/or methods disclosed herein, or particular components thereof, may in some embodiments be implemented as software comprising instructions executed on one or more programmable device. By way of example, components of the disclosed systems may be implemented as an application, an app, drivers, or services. “Service” refers to a process configurable with one or more associated policies for use of the process. Services are commonly invoked on server devices by client devices, usually over a machine communication network such as the Internet. Many instances of a service may execute as different processes, each configured with a different or the same policies, each for a different client. “App” refers to a type of application with limited functionality, most commonly associated with applications executed on mobile devices. Apps tend to have a more limited feature set and simpler user interface than applications as those terms are commonly understood in the art. In one particular embodiment, the system is implemented as a service that executes as one or more processes, modules, subroutines, or tasks on a server device so as to provide the described capabilities to one or more client devices over a network. “Task” refers to one or more operations that a process performs. “Subroutine” refers to a module configured to perform one or more calculations or other processes. In some contexts the term ‘subroutine’ refers to a module that does not return a value to the logic that invokes it, whereas a ‘function’ returns a value. However herein the term ‘subroutine’ is used synonymously with ‘function’. However the system need not necessarily be accessed over a network and could, in some embodiments, be implemented by one or more app or applications on a single device or distributed between a mobile device and a computer, for example.

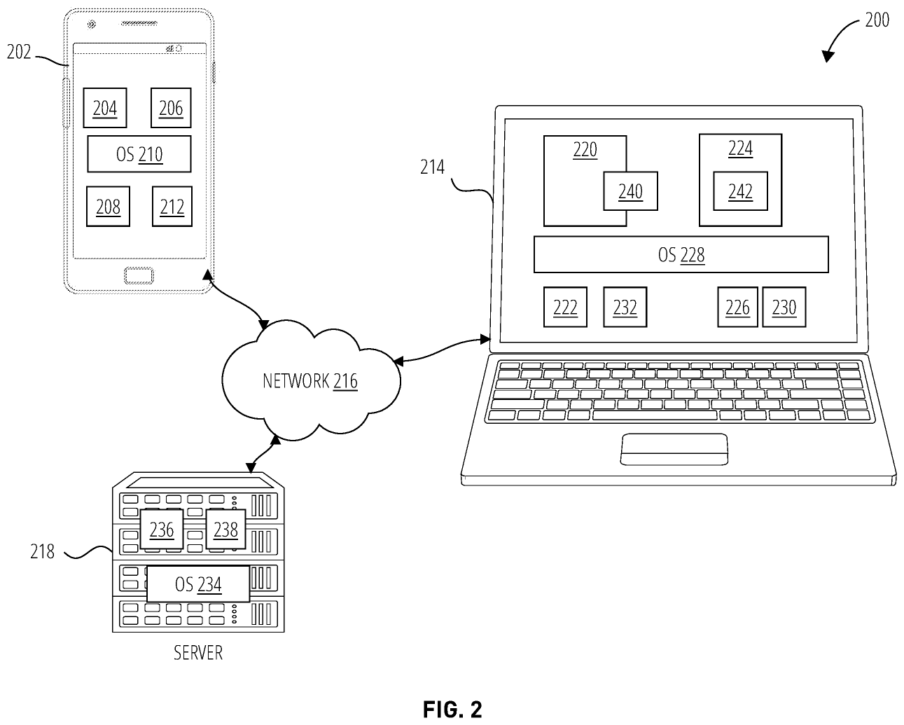

Referring to FIG. 2, a client server network configuration 200 illustrates various computer hardware devices and software modules coupled by a network 216 in one embodiment. Each device includes a native operating system, typically pre-installed on its non-volatile RAM, and a variety of software applications or apps for performing various functions.

The mobile programmable device 202 comprises a native operating system 210 and various apps (e.g., app 204 and app 206). A computer 214 also includes an operating system 228 that may include one or more libraries of native routines to run executable software on that device. “Executable” refers to a file comprising executable code. If the executable code is not interpreted computer code, a loader is typically used to load the executable for execution by a programmable device. The computer 214 also includes various executable applications (e.g., application 220 and application 224). “Loader” refers to logic for loading programs and libraries. The loader is typically implemented by the operating system. A typical loader copies an executable into memory and prepares it for execution by performing certain transformations, such as on memory addresses. The mobile programmable device 202 and computer 214 are configured as clients on the network 216. A server 218 is also provided and includes an operating system 234 with native routines specific to providing a service (e.g., service 238 and service 236) available to the networked clients in this configuration.

As is well known in the art, an application, an app, or a service may be created by first writing computer code to form a computer program, which typically comprises one or more computer code sections or modules. “Computer program” refers to another term for ‘application’ or ‘app’. Computer code may comprise instructions in many forms, including source code, assembly code, object code, executable code, and machine language. “Assembly code” refers to a low-level source code language comprising a strong correspondence between the source code statements and machine language instructions. Assembly code is converted into executable code by an assembler. The conversion process is referred to as assembly. Assembly language usually has one statement per machine language instruction, but comments and statements that are assembler directives, macros, and symbolic labels may also be supported. Computer programs often implement mathematical functions or algorithms and may implement or utilize one or more application program interfaces. “Algorithm” refers to any set of instructions configured to cause a machine to carry out a particular function or process.

A compiler is typically used to transform source code into object code and thereafter a linker combines object code files into an executable application, recognized by those skilled in the art as an “executable”. “Linker” refers to logic that inputs one or more object code files generated by a compiler or an assembler and combines them into a single executable, library, or other unified object code output. One implementation of a linker directs its output directly to machine memory as executable code (performing the function of a loader as well). The distinct file comprising the executable would then be available for use by the computer 214, mobile programmable device 202, and/or server 218. “Library” refers to a collection of modules organized such that the functionality of all the modules may be included for use by software using references to the library in source code. Any of these devices may employ a loader to place the executable and any associated library in memory for execution. The operating system executes the program by passing control to the loaded program code, creating a task or process. An alternate means of executing an application or app involves the use of an interpreter (e.g., interpreter 242).

In addition to executing applications (“apps”) and services, the operating system is also typically employed to execute drivers to perform common tasks such as connecting to third-party hardware devices (e.g., printers, displays, input devices), storing data, interpreting commands, and extending the capabilities of applications. For example, a driver 208 or driver 212 on the mobile programmable device 202 or computer 214 (e.g., driver 222 and driver 232) might enable wireless headphones to be used for audio output(s) and a camera to be used for video inputs. Any of the devices may read and write data from and to files (e.g., file 226 or file 230) and applications or apps may utilize one or more plug-in (e.g., plug-in 240) to extend their capabilities (e.g., to encode or decode video files). “Plug-in” refers to software that adds features to an existing computer program without rebuilding (e.g., changing or re-compiling) the computer program. Plug-ins are commonly used for example with Internet browser applications.

The network 216 in the client server network configuration 200 may be of a type understood by those skilled in the art, including a Local Area Network (LAN), Wide Area Network (WAN), Transmission Communication Protocol/Internet Protocol (TCP/IP) network, and so forth. These protocols used by the network 216 dictate the mechanisms by which data is exchanged between devices.

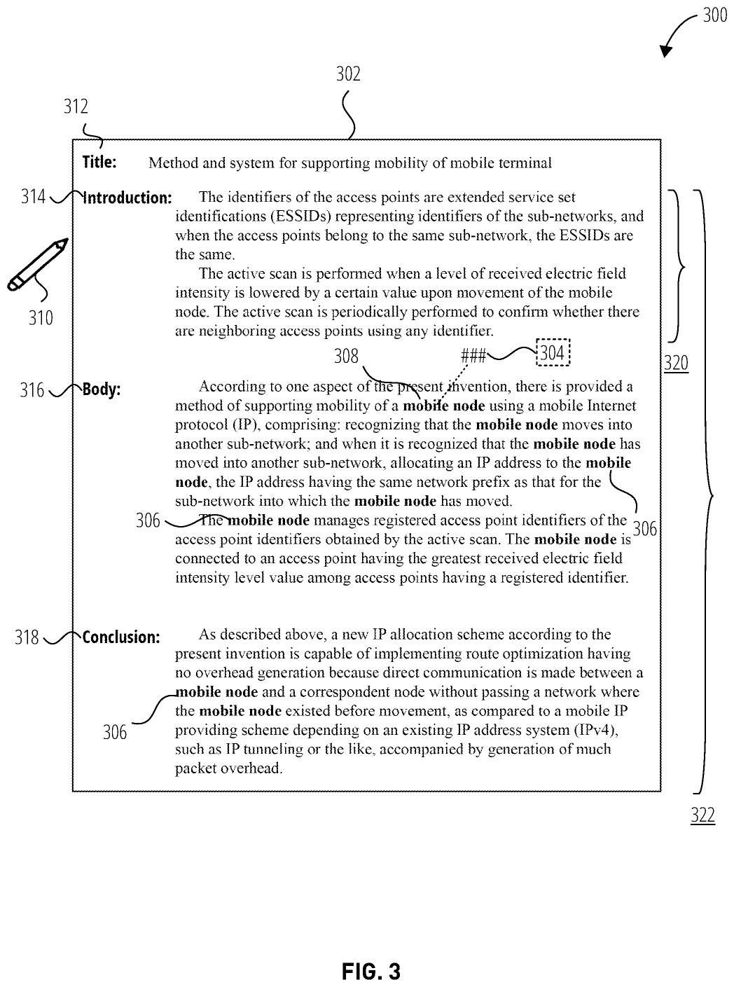

Referring to FIG. 3, an example document 300 is illustrated. In particular, FIG. 3 illustrates the concept of a first occurrence of a term. The claimed solution provides for automatic insertion of a definition for one or more terms in text. “Text” refers to a collection of words, phrases, and/or symbols configured to convey information in a human readable format. In one embodiment, “text” refers to a main body of printed or written matter of a document. Often, text is organized into a format such as a document. “Document” refers to a collection of words, phrases, and/or symbols organized on, or in, a medium to communicate, preserve, and/or retain information. In one embodiment, a document comprises two or more sections. In certain embodiments, a document comprises a set of ordered sections. Those of skill in the art will appreciate that text and/or a document may exist in a logical form (e.g., data and data structures stored in memory and/or displayed on a display device that may include a graphical user interface) and/or a physical form (e.g. printed versions of the text or document on a page or other media or in a book or other printed work).

Certain text may employ a specialized set of words, symbols, formulas, abbreviations, acronyms, terms, or the like, to convey the desired concepts to the reader. “Set” refers to a group or collection of things. In one embodiment, a set includes one or more things. In another embodiment, a set include zero or more elements. The specialized set of words, symbols, formulas, abbreviations, acronyms, terms, and the like are referred to herein as terms. “Term” refers to a word, expression, phrase, set of letters, set of letters and/or symbols, and/or symbol that has a precise meaning. In certain embodiments, a term may comprise a term type comprising one or more of an abbreviation, an acronym, a word, and a phrase. Terms may be defined by a user, an author, and/or by an automated process, or a combination of these. “Author” refers to any person that reviews, composes, edits, and/or revises text, a document or a set of documents.

In certain embodiments, terms may be associated with definitions that explain what the term means or alternatively, or in addition, represent a formal or verbose form of the symbol, word, term, concept, idea, or formula represented by the term. In certain written text, an author 310 may desire that one or more terms used in the text include their associated definition(s). This may be accomplished by including a glossary with the text.

Some authors may want to provide a definition for each term within the text and shortly after the term is introduced, or used, within the text. Placement of a definition in this manner is called an inline definition. “Inline definition” refers to a definition positioned within or near a paragraph such that the term defined by the definition follows a first occurrence of the term. Alternatively, or in addition, an author may want to replace a term with its definition. By automating insertion of definitions for term(s), an author may use more creativity and draft text for a document without technical concerns such as how or where to include associated definitions.

In certain embodiments, the order and position of a term and its associated definition may be important. Generally, text comprises an ordered set of content having a beginning and an end. Certain authors may want to have a definition in the text subsequent to where the associated term appears within the text. Still other authors may want to have a definition in the text subsequent to where the associated term first appears within the text. This is referred to as a first occurrence. “First occurrence” refers to first instance of a term within a sentence, paragraph, subsection, section, document, or set of documents.

FIG. 3 illustrates a set of text organized into a document 302 which is organized into one or more sections. “Section” refers to a set of words, phrases, and/or symbols organized into part of a document. In certain embodiments, a section is a mechanism for organizing the information and material presented in a document such that the information is presented in a predefined, accepted, mandated, standard, or regulated manner. For example, in a patent document, prescribed sections may be defined by regulation or law. In one embodiment, a section comprises a structural component of a document. In one embodiment, the content of a section is represented by one or more strings of text. The strings of text may be organized into sentences and/or paragraphs and may include punctuation and/or symbols and/or tags that define markup language elements in a markup language. In certain embodiments, text may be organized into paragraphs, sentences, a particular type of section such as a detailed description section, a set of documents, and/or a particular type of document such as a patent document, or the like.

“Paragraph” refers to an ordered set of sentences organized to convey one or more concepts to a reader. Often, the one or more concepts are related to each other and/or relate to one or more general topics.

“Detailed description section” refers to a section of a patent document that describes how to make and/or use an invention recited in a claims section. In certain embodiments, a “detailed description section” may be referred to simply as a “description section”. For example, where the patent document is an international application filed under a Patent Cooperation Treaty, the terms “detailed description section” and “description section” may be synonymous. Consequently, in certain embodiments, “detailed description section” may refer to a section of a mandatory part of the international application which discloses the invention in a manner sufficiently clear and complete for the invention to be carried out by a person skilled in the art. “description” wipo.int. World Intellectual Property Organization glossary, 2019. Web. 28 Aug. 2019.

In the illustrated example of FIG. 3, the document 302 includes a title 312 section, introduction 314 section, body 316 section, and conclusion 318 section. The sections 322 may, or may not, include headers that label the sections.

In one embodiment, a process for automatically inserting definitions starts by searching the text for terms that have associated definitions. Once a term is located, an insertion point is determined for the definition relative to its associated term. “Insertion point” refers to a position within an ordered set of text for inserting another set of text such as a definition. Next, an associated definition is combined with the text at the insertion point. In certain embodiments, definitions may be inserted only in particular sections 322. In such an embodiment, only those particular sections 322 may be searched for terms that have associated definitions.

Those of skill in the art will appreciate that identifying a term within a set of text and distinguishing one instance of a term relative to others means that the text may comprise an inherently ordered set of content. In addition, distinguishing one instance of a term relative to others depends on how the text, particularly text with an ordered set of content, is searched for instances of the term. In one embodiment, the document is searched from its beginning (e.g., the top left hand corner, as displayed in FIG. 3) to its end (e.g., the bottom right hand corner, as displayed in FIG. 3). Since the document is ordered and the search is done from beginning to end the first instance of a term with an associated definition, will be the first occurrence.

In the illustrated example of FIG. 3, suppose the document is ordered as illustrated, with the sections illustrated and that the term “mobile node” includes an associated definition. In such an example, the claimed solution locates the first occurrence 308 of the term “mobile node” within the body of the document 302. The term may be located in any position in the document 302 text, including within a sentence, paragraph, section 320, header, and so forth, or at the start of end of any of these constructions. The term may also be embedded within the definition of another term.

As noted above, an insertion point 304 is defined for a definition, associated with a term 306, to be combined with the text. The location of the insertion point 304 depends on variables related to both the term being defined and the structure of the definition. The insertion point 304 may be defined relative to the term location. Since inserting a definition within a sentence may create a non-linear reading experience, the insertion point 304 may thereby be at the end of a sentence or end of a paragraph containing the term 306. Locating the insertion point 304 also accounts for sentence structure. Defining an insertion point 304 (i.e., inserting a definition) may make sense within a clause and within an ordered list. Paragraph structure may also be considered. An insertion point 304 at the end of a paragraph when the term resides at the beginning somewhat defeats the purpose of an inline definition.

Many documents also insert definitions based on term type. For example, a technical document may define an acronym or abbreviation in a separate section but retain a term definition on the same page. A patent document may define a claim term in a glossary or with an inline definition. The insertion point 304, therefore, additionally account for the type of the term to which it is inserting a definition. In another embodiment, an insertion point 304 may be defined based on the first occurrence 308 position of the term 306 within the text comprising one of the sentence, paragraph, detailed description section, document, set of documents, and patent document. The insertion point 304 associates exclusively with the first occurrence 308 of the term 306 in the document 302.

The structure of the text comprising the definition also affects the insertion point location. A definition may be a single sentence or phrase without line breaks before or after the text. In this case an insertion point may be appropriate inline, e.g., within a sentence, at the end of a sentence, or a similar position in the text appropriate for a limited amount of text. If the definition comprises multiple paragraphs, e.g., a block-level element, the insertion point may belong at the end of a paragraph or possibly at a dedicated location, e.g., in a glossary.

Once the insertion point 304 has been defined, the term 306 associated with the insertion point 304 may be paired with its definition and removed from consideration for additional searches. Note, however, that terms may be rearranged in such a manner than the first occurrence 308 of a term 306 may be relocated (e.g., “cut and pasted” by a user interaction in a word processing software program well known to those skilled in the art) to a point closer to the end of the document 302 so that an additional occurrence of the term 306 becomes the first occurrence 308. In one embodiment, the new first occurrence 308 is automatically updated based on a refresh of the predefinition process, thereby removing the insertion point 304 of the previous first occurrence 308.

FIG. 3 illustrates use of the claimed solution in relation to text and in particular in relation to text organized into a document. Those of skill in the art recognize that this claimed solution may be used with a variety of different types of documents. In particular, the claimed solution may be used with documents that rely on or include definitions for particular terms. Examples of such documents include, but are not limited to, legal contracts, patent applications, grant funding applications, scholastic theses, accounting reports, investment disclosures, and the like.

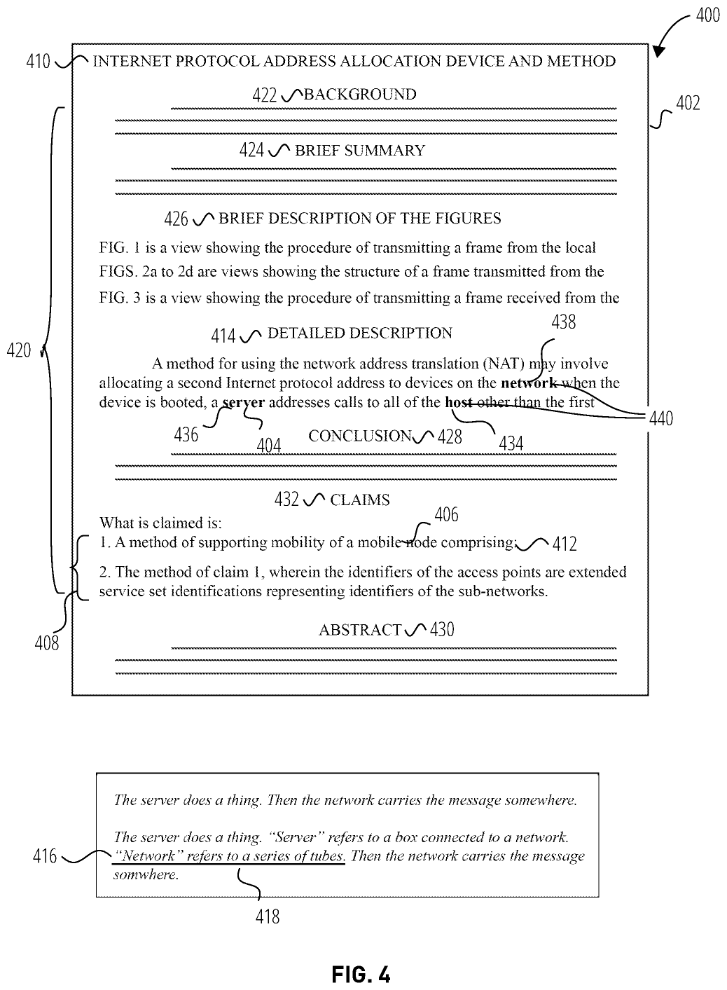

Referring to FIG. 4, an example document 400 is illustrated. In the embodiment of FIG. 4, the example document 400 comprises a patent document 402. “Patent document” refers to a document created and used in connection with the application process and/or the procurement of a granted patent. Patent document refers to both national patent applications and/or international patent applications and/or both national patent grants and/or international patent grants. References to a “patent document” refer also to an application for the protection of an invention. References to an “application” include, but are not limited to, references to applications for patents for inventions, inventors' certificates, utility certificates, utility models, patents or certificates of addition, inventors' certificates of addition and utility certificates of addition. A patent document 402 comprises a number of sections. Sections of a patent document may be required by government regulations or code and may be organized into a required order. The required order may start at the beginning of the document and proceed to the end of the document. Such an order of the sections is referred to herein as a set of ordered sections 420. “Ordered sections” refers to a set of sections organized into a predefined order. In certain embodiments, the ordering of the sections is done to promote uniformity and facilitate presentation and organization of certain information. Certain documents, such as patent documents may designate a prescribed order for the sections. As a representative example, in a patent document such as a United States patent application, the first section is the title, the second section is the cross-reference section, the third section is the background section, the fourth section is the summary section, the fifth section is the brief description of the figures section, the sixth section is the detailed description section, the seventh section is the claims section, and the abstract section is the final section. The patent document may optionally include a drawing section which may not have a predefined order relative to the other ordered sections of the patent document. The patent document 402 may comprise a number of ordered sections 420, e.g., background section 422, summary section 424, description of the drawings section 426, detailed description section 414, conclusion section 428, abstract section 430, and claims section 432. The order of the ordered sections may be starting from the upper left hand corner and proceeding to the lower right hand side, traversing the left hand column and then the right hand column: background section 422, summary section 424, description of the drawings section 426, detailed description section 414, conclusion section 428, abstract section 430, and claims section 432.

Ordered sections facilitate identification of a first occurrence of a term. In one embodiment, a computing apparatus, such as the computing device 100 of FIG. 1, may operate to insert definitions for associated terms. In such an embodiment, the computing device 100 may scan one or more of the ordered sections 420 of the patent document 402 for a term 440. In certain embodiments, the computing device 100 may scan one or more of the ordered sections 420 of the patent document 402 for a term 440 having an associated definition. In one embodiment, the computing device 100 may scan each of the ordered sections 420, starting at a head 410 of the patent document 402 for a term 440. In another embodiment, the computing device 100 may scan certain ordered sections 420 for a term 440. For example, the computing device 100 may be configured to scan the summary section 424 and the detailed description section 414.

When the computing device 100 finds a term 440 that includes an associated definition, the computing device 100 determines an insertion point, as described above and shown in FIG. 3. Once the insertion point is determined, the computing device 100 may insert the definition into the document at the insertion point. Inserting text comprises two steps. First, the computing device 100 writes a copy of the definition into a temporary memory buffer, accounting for its location in volatile memory as needed. Second, the computing device 100 reads the definition from the temporary memory buffer and writes the string of characters into the updated version of the document.

In the depicted embodiment, the patent document 402 is associated with a number of terms. Certain ones of these terms may each include an associated definition. Such terms are defined terms. “Defined term” refers to a term that has an associated definition. Other terms of the number of associated terms for the patent document may not have an associated definition. In certain embodiments, a patent document 402 may be associated with only defined terms.

In the patent document 402 of FIG. 4, “host 434”, “server 436”, and “network 438” may each be terms associated with the patent document 402. Further, “server 436” and “network 438” may each have an associated definition. In this example, “server 436”, and “network 438” are defined terms and “host 434” is an undefined term. In this example, the computing device 100 scans the patent document 402 starting with the background section 422 and progressing through each section, including the detailed description section 414.

Within the detailed description section 414, the computing device 100 finds the term “server.” In one embodiment, the computing device 100 next determines an insertion point and then inserts the definition for “server” into the text content at the insertion point. Because the computing device 100 started scanning from the head 410 and found the first instance of “server 436” in the detailed description section 414, this instance is the first occurrence. Consequently, the inserted definition will be at or near the first occurrence of the term “server 436”. The computing device 100 may follow the same process for the term “network 438” and may skip scanning the patent document 402 for the term “host 434” because this term is not a defined term.

In certain embodiments, a defined term may include one or more terms and/or one or more defined terms. In such an embodiment, the computing device 100 may scan each ordered section in order. In addition, each ordered section may include an ordered set of paragraphs 408. Consequently, the computing device 100 may scan each paragraph of each ordered section in order. In this manner, the first occurrence of a defined term may be located, and the associated definition inserted. In certain embodiments, the computing device 100 may determine whether the definition of a first defined term includes a defined term (i.e., an embedded defined term). If so, the computing device 100 may insert the definition for the first defined term as described above and then re-start the scanning of the ordered section (or the patent document 402), searching for the defined term included in the definition of the first defined term. In this manner, the definitions for defined terms are inserted at an insertion point that is closest to the first occurrence of the defined term.

Since definitions may themselves contain terms, sometimes inserting a definition may create a new first occurrence of a term. An example of a defined term within a definition of a defined term is provided for illustration. In this example, text of a patent document 402 is as follows:

### Example Text #1

“The server sends a response message. Then, the network carries the response message to point A.”

Further, the definition for “server 436” may be “a computing device connected to a network 438.” and the definition for “network 438” is “a series of interconnected nodes.” If the insertion point for the term “server 436” is after the sentence that includes the term “server 436” and “network 438” in the Example text above, and is the first occurrence of “network 438” in the patent document 402, then insertion of the definition for “server 436” will create a new first occurrence for the term “network 438” because the defined term “network 438” is in the definition for the term “server 436”. Example text #2 illustrates the result after the insertion of the definition for “server 436”.

### Example Text #2

“The server sends a response message. “Server” refers to a computing device connected to a network. Then, the network carries the message somewhere.” (underlining for illustration)

Because the computing device 100 re-starts the scanning of the ordered section (or the head 410 of the patent document 402) searching for defined term, “network 438”, that does not yet have a definition inserted, in one embodiment, the computing device 100 locates the term “network 438” in the recently inserted term “network 438” that occurs before the original first occurrence of “network 438”. Next, the computing device 100 inserts the definition for the defined term, also referred to herein as a defined term definition 418, at a second insertion point 416 relative to the defined term “network 438” which is in the definition of the defined term “server 436”. “Defined term definition” refers to a definition for a defined term. “Second insertion point” refers to a position within an ordered set of text for inserting another set of text such as a definition wherein the second set of text includes a defined term and its definition is inserted immediately following the definition of the first set of text. Example text #3 illustrates the result after the insertion of the definition for “network 438”, where the second insertion point is following the sentence that includes the term “network 438”.

### Example Text #3

“The server sends a response message. “Server” refers to a computing device connected to a network. “Network” refers to a series of interconnected nodes. Then, the network carries the response message to point A.” (underlining for illustration)

In one embodiment a user may manually configure the insertion point either before or after the first occurrence. Since the computing device 100 maintains both insertion points and terms, a user interface displayed by the computing device 100 may allow a user to locate the insertion point anywhere in a document containing the term. The user interface may allow a user to reference the term, move a cursor or other on-screen indicator to a location in the document, select the location (e.g., by executing an interactive command from an input device) and execute a simple command to insert the definition.

In another embodiment, a term comprises a claim term 406, or a term specifically defined for use in the context of a patent claim 412. Determining insertion points and combining definitions with terms follows relatively specific rules in the context of patent documents. A definition accompanies each claim term 406 but the insertion point location allows some flexibility. Definitions are placed after the term and may only be inserted once. As with terms defined in other documents, the definition may be a sentence without line breaks, a paragraph, or a block-level element comprising multiple paragraphs in various forms (e.g., lists).

Accounting for the conditions identified above, inserting a definition for a claim term 406 in a patent document 402 comprises three steps, provided the claim term 406 comprises a defined term. First, a computing device 100 scans the ordered sections 420 of the patent document 402 to search for the term. The order of the ordered sections may be starting from the upper left hand corner and proceeding to the lower right hand side, traversing the left hand column and then the right hand column: background section 422, summary section 424, description of the drawings section 426, detailed description section 414, conclusion section 428, abstract section 430, and claims section 432. The scanning process finds a claim term 406 with a definition, e.g., a defined term 404, by a text string search performed by the computing device 100. If the claim term 406 has not previously been found, an insertion point is introduced to accompany the found term.

The second step for inserting a claim term 406 definition into a patent document 402 is determining the insertion point location. As noted above, the definition appears after its accompanying claim term 406 but may be an inline definition or appear elsewhere. A user or author may use the computing device 100 to specify the insertion point location based on both the patent document rules of placing claim term 406 definitions and the structure of the definition itself, e.g., whether the definition text is a sentence without line breaks, a paragraph, or a block-level element comprising multiple paragraphs. One insertion point may be defined for every claim term 406.

With a claim term 406 found and an insertion point determined, the final step of inserting a claim term 406 definition may be completed. “Claim term” refers to a term used in a patent claim. At the insertion point the computing device 100 copies the definition accompanying the claim term 406 into the patent document 402 and reformats the resulting text according to the insertion point location and the structure of the definition as previously discussed. With the definition now inserted, the scanning process discussed above stops searching for the same claim term 406 as the claim term 406 definition may only be represented once in the patent document 402.

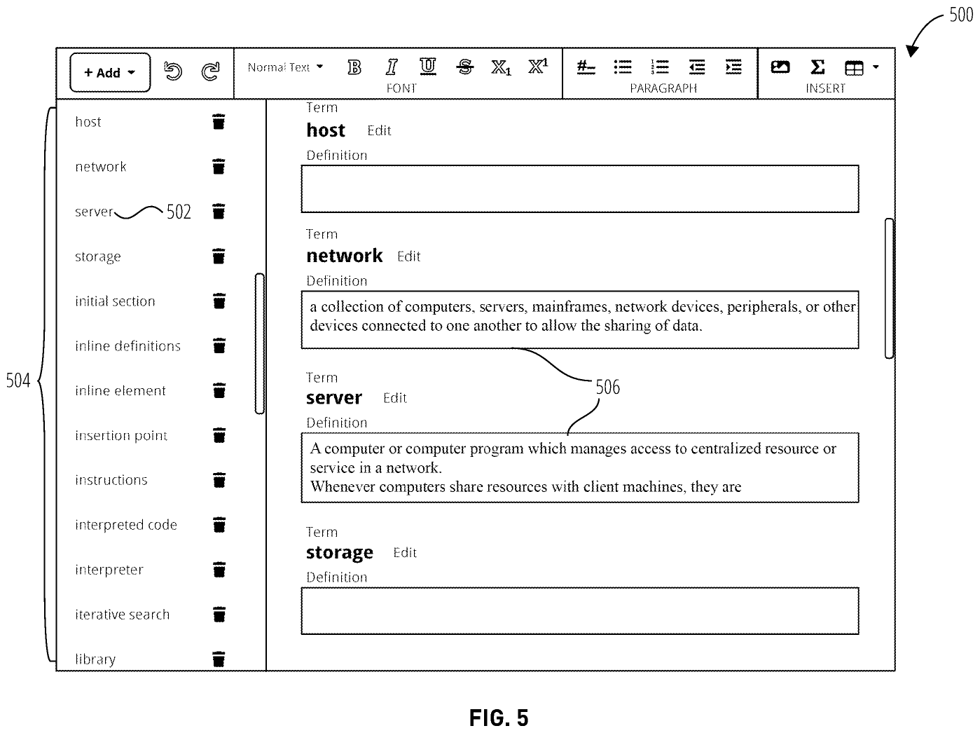

Referring to FIG. 5, a listing of terms and definitions 500, or glossary, is illustrated. For each term 502, such as “server” or “network” as shown, an accompanying definition 506 displays in a glossary as exemplified in the interface as described. A collection of terms or defined terms collectively defines a term set 504.

The glossary interface as shown accommodates a plurality of text structures for definitions. A definition 506, as exemplified by that for network, may be a single string of text or a sentence with no line breaks. If a definition takes this form, the text comprising the definition for a term 502 may be inserted at an insertion point in a document in a variety of ways: replacing the term itself, following the term, before the term, at the end of a sentence or end of a paragraph containing the term, and so on. A text structure comprising a single string of text or a sentence with no line breaks represents the most flexible means of inserting a definition into a document.

As shown by the definition 506 for “server”, a definition in a glossary for a defined term may take the form of one or more paragraphs. If a definition takes this form, the text comprising the definition for a term 502 may be inserted at an insertion point in a document in a proscribed form. A multi-paragraph text structure may not be effectively inserted as an inline definition. Definitions taking this form or more complex forms known to those skilled in the art (e.g., bulleted lists) may typically insert at the end of a paragraph or elsewhere in a document.

A term set 504 comprises the complete list of terms which may or may not include definitions. These definitions may take any form as previously described, e.g., a single string of text or a sentence with no line breaks or one or more paragraphs with or without line breaks. In an interface as shown, a user or author may type in text for either of these definition types to define a term. This definition may then be inserted when an insertion point for the term it defines is located as described above and illustrated in FIG. 4.

“Definition” refers to a statement of the meaning of a word or word group or a sign or symbol, such as a keyword. In certain embodiments, a definition comprises a term, one or more words, phrases, or symbols, and punctuation organized into a sentence. In one embodiment, a definition comprises one or more sentences organized into one or more paragraphs. In certain embodiments, a definition may replace a keyword. In one embodiment, a definition may include the keyword associated with the definition. In one embodiment, a definition comprises an expanded form of an abbreviation, an acronym, or the like. “Term set” refers to a plurality of terms.

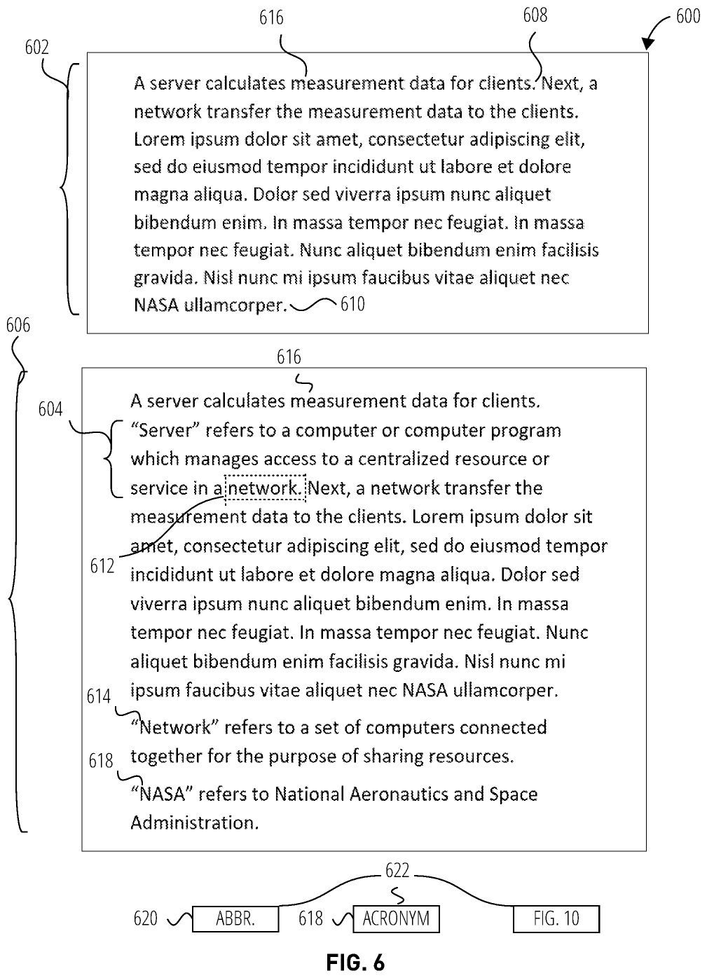

Referring to FIG. 6, definitions and insertion points at different positions 600 are illustrated. Two sections of text 616 are shown comprising a number of embedded terms. In several embodiments the sections may be ordered sections, initial sections, and/or predetermined sections of a document. “Initial section” refers to a section that is first in an ordered set of sections. In other embodiments, the text 616 may comprise one of a sentence, a paragraph, a detailed description section, a document, a set of documents, and a patent document. As shown and described in FIG. 3 above, the position of a term defines an insertion point into which the term definition inserts. FIG. 6 herein describes the variability of insertion point position for a definition, including within a definition itself.

In one embodiment the insertion point within a section 602 may comprise an end of a sentence 608 that comprises the term itself. Thus, a definition for the term “server” may display nested in the text 616 immediately following the end of a sentence 608 containing the term “server”. In another embodiment the insertion point within a section 602 may comprise an end of a paragraph 610 that comprises the term. Thus, a definition for the term “network” may display appended to the text 616 at the end of a paragraph 610 containing the term “network”.

A term may be defined according to type. A term type 622 may be a claim term or figure term in a patent document, an abbreviation 620, a term of art, an acronym 618, and so on. The computing apparatus described above and shown in FIG. 1 comprises memory storing instructions that may in certain embodiments determine an insertion point, additionally determine the term type for a specific term, and thereby define the insertion point based on the term type. For example, as shown the term type 622 of acronym 618 may comprise the term “NASA,” and based on that term type 622 the insertion point may be defined as an inline definition, end of a paragraph or end of a sentence depending on the contextual use within the text 616.

In certain embodiments the definition of a term may additionally comprise a second definition 614. In this instance, the computing apparatus described above comprises memory storing instructions that may search each subsection 604 of every ordered section 606, in order, for a first occurrence of the term. As previously described, the apparatus inserts a definition of the term at the insertion point, where the insertion point may comprise a position (e.g., end of a sentence, end of a paragraph) following a subsection 604 comprising the first occurrence. At this point, the apparatus may then search the subsection 604, comprising the inserted definition for a second term 612 (e.g., “network”) and then inserting a definition for the second term 612 at a position (e.g., end of a sentence, end of a paragraph) after the inserted definition.

“Term type” refers to a type of term including an abbreviation, an acronym, a claim term, a figure term, and the like. “Subsection” refers to a set of words, phrases, and/or symbols organized into part of a section. A subsection organizes the words, phrases, and/or symbols to convey one or more topics. One example of a subsection is a paragraph.

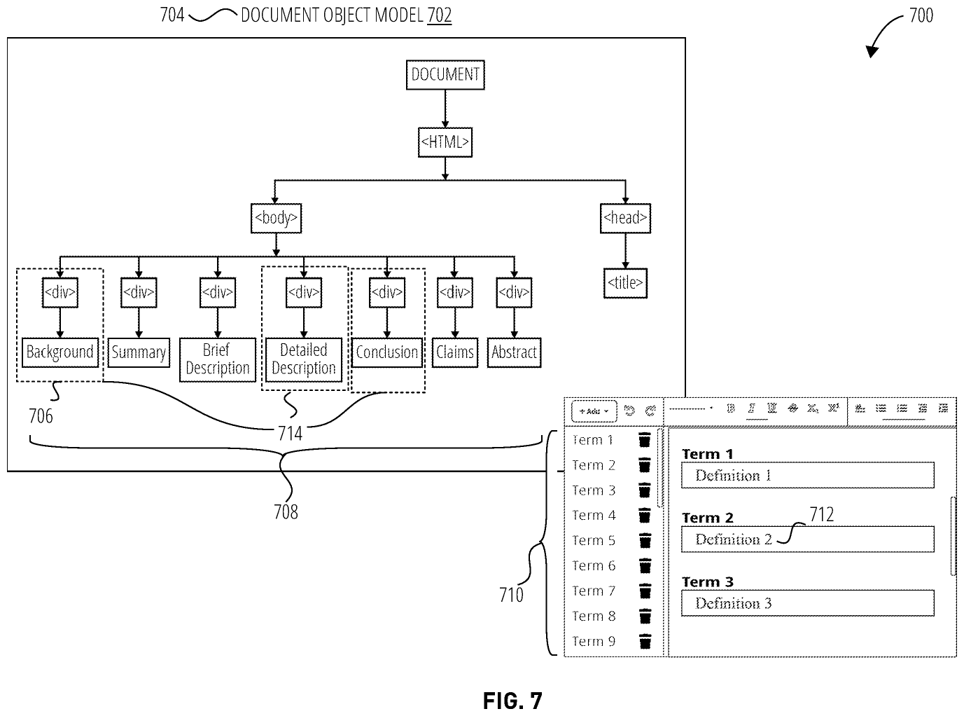

FIG. 7 illustrates a document object model 700 determined for a patent document. To enact the determination, for certain embodiments a non-transitory computer-readable storage medium, exemplified by memory as described above, includes instructions that when executed by a computer cause the computer to determine a document object model 702 (or DOM 704) for a patent document. As shown, the DOM 704 comprises a structure for a document and may additionally apply to a sentence, a paragraph, a detailed description section, a set of documents, and a patent document. The document structure comprises a collection of nested tags, very well known to those skilled in the art and exemplified herein by the Hypertext markup language (HTML), itself comprising a tag, specifically a start tag (i.e., <HTML>) to an HTML document coupled with an end tag (i.e., </HTML>, not shown). Nested tags between the start tag and end tags comprise a head tag (i.e., <head>) and title tag (i.e., <title>), primarily used to identify the document itself, and a body tag (i.e., <body>) comprising document contents. Nested tags also pair with end tags (i.e., </head>, </title>, </body>, not shown). An additional set of nested tags within the start tag and end tag of the body tag comprise division (e.g., <div>) tags defining the predetermined sections 714 of a patent document, i.e., background section, summary section, brief description section, detailed description section, conclusion section, claims section, and abstract section. The text of each of these predetermined sections 714 comprise the content of the HTML document within the <div> tags, e.g., after a <div> start tag and a </div> end tag.

For certain embodiments the non-transitory computer-readable storage medium, including instructions that when executed by a computer, cause the computer to determine a term set 710 from the terms in a patent document, collected in a listing of terms and definitions 500 as described above and shown in FIG. 5. Each term in this case comprises an associated definition 712. The instructions, executed by a computer, then cause the computer to search predetermined sections 714 (e.g., detailed description section and so on) of the DOM 704 for a term in the term set 710. For each term in the term set 710, the instructions, executed by a computer, then cause the computer to match the term in the term set 710 with a term in the text of the predetermined sections 714, beginning with the initial section 706, whereupon the computer then merges a definition into the text of the predetermined sections 714.

As the definition may only be inserted once, when a term from a term set 710 has been matched with a term in the text of the predetermined sections 714 and a definition merged into the text as described, the instructions that when executed by a computer, cause the computer to remove the term from the term set. In certain embodiments the instructions then conduct an iterative search of each section of the predetermined sections, starting at an initial section, for each term in the term set. “Iterative search” refers to a search conducted on a document or set of documents in which the same document or set of documents is searched multiple times with a different set of criteria on each search until a termination condition is reached. The process of inserting definitions completes when all terms have been removed from the term set 710 by way of this iterative search, term matching, and merging of definitions into the text of the predetermined sections 714.

The process described above of matching terms in the term set 710 with terms in the text of predetermined sections 714 and merging the term definition into text of predetermined sections 714 applies particularly to documents with ordered sections. In certain embodiments, the instructions that when executed by a computer, may cause the computer to order predetermined sections 714 according to a document order 708 for a patent document, which, as known to those skilled in the art, has a specific document order 708 of its sections. Since a patent document relies on a definition following a first occurrence of a term, the instructions may further cause the computer to search the predetermined sections 714 in order, i.e., from top of the document to the bottom of the document, such that merging the term definition into a section (e.g., background section, detailed description section, conclusion section) of the predetermined sections 714 results in the definition following a first occurrence of the term.

“Predetermined sections” refers to a set of sections defined by a standard, rule, configuration, policy, or user preference. In one embodiment, predetermined sections comprise a subset of the sections for a document, such as a patent document. For example, in a patent document the predetermined sections may comprise a background section and a detailed description section. “Initial section” refers to a section that is first in an ordered set of sections. “Document object model” refers to a logical representation of a document. A document object model may be represented as an in-memory data structure, such as a tree data structure and be referred to by the abbreviation DOM. In certain embodiments, the DOM comprises an in-memory tree data structure that is a logical representation of a document. A document object model may be represented as a persistent data structure, such as a file. In certain embodiments, a document object model is stored in a file in the form of a markup language such as HTML or XML.

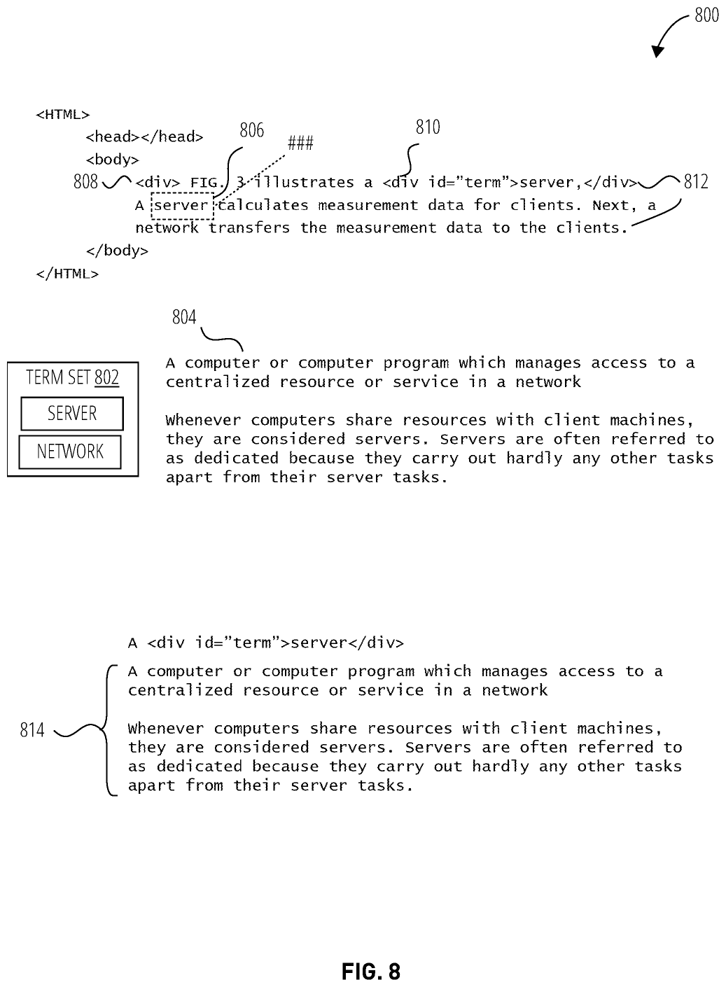

Referring to FIG. 8, a block-level element insertion based on tagging identified text 800 is illustrated. In one embodiment, as shown, each section 812 of a text document may be represented by a markup language string 808. In certain embodiments, a section 812 of a document may comprise an ordered sections, initial sections, and/or predetermined sections of a document. In other embodiments, the text within a section may comprise one of a sentence, a paragraph, a detailed description section, a document, a set of documents, and a patent document. Each term as described above may be represented within the markup language string 808 by a unique tag 810. In one embodiment, the markup language (e.g., HTML) identifies a markup language string 808 such as “<div>FIG. 3 illustrates a <div id=”term“>server</div>” and a unique tag 810 such as “<div id=”term“>server</div>” represents a term (e.g., “server”). The term may be defined in the term set 802, as shown, and include a definition to comprise a defined term.

Using the markup language that includes tags and, in this case, unique tags, in a text document allows the instructions described above to cause the computer to search the text for the markup language string 808 for the term matching the unique tag 810. Note this search occurs when the term set 802 comprises the term (e.g., “server”) since it includes a definition 804. Specifically, the search scans the markup language string 808 for the term (“server”) contained in both the unique tag 810 (“<div id=”term“>server</div>”) and the set of defined terms in the term set 802.

In certain embodiments, the instructions cause the computer to perform a search as described above on predetermined sections of the document object model (or DOM) applied to a document type, e.g., a patent document. For example, the search may scan at least the background section, the detailed description section and the conclusion section of a patent document for a specific term or terms included in the term set (i.e., incudes a definition). As described above for a general case, the instructions cause the computer to search the text in the predetermined sections of the patent document for the markup language string 808 for the term matching the unique tag 810.

In one embodiment, the text in predetermined sections does not yet include a tag, so the search comprises identifying text in the predetermined sections, thereby making it identified text, and matching the identified text with a term in the term set. The identified text may then be tagged, e.g., uniquely associated with the matching term for later use. This later use may comprise any use possible within the tagging functionality of the markup language: with the term tagged a later insertion may include supplementary text information (e.g., word suggestions, spelling corrections), embedded graphics, video or other media known to those skilled in the art to include in a document.

In another embodiment, the definition 804 of a term in the text in predetermined sections comprises a text format known in the art as a block-level element 814, or the treatment of text as a “block” comprising a number of formats beyond a sentence. Exemplary block-level elements may include multi-sentence paragraphs, bulleted lists, quotations, multiple paragraphs, indented paragraphs, and so on. Since block-level elements may comprise formatting unsuitable for displaying as an inline element, e.g., shown immediately following the term, in one embodiment the instructions cause the computer to merge the definition formatted as a block-level element 814 into text such that the definition is inserted at the insertion point 806 as a new paragraph—that is, following the paragraph that includes the term. As shown in FIG. 8, the block-level element 814 comprises a multi-paragraph block of text (“a computer or computer program . . . ”) formatted as the definition 804 of the term (“server”) and inserted following the paragraph that includes the term.

As noted above, the first occurrence of a term in a document such as a patent document serves a specific use as such document types typically require term definitions in particular contexts. Since the term set 802 retains a list of all defined terms, and the iterative search described above removes terms after insertion into the document, scanning for the first occurrence of a term within a DOM represents an extension of the same function. In this case, the instructions that cause the computer to search predetermined sections of the DOM for text, unique tags, markup language strings and so on, may also be employed to search the predetermined sections of the DOM for a first occurrence of the term. “Markup language string” refers to a string of text that includes one or more markup language elements. Examples of a markup language string include, but are not limited to, a Hyper Text Markup Language (HTML) string, an eXtensible Markup Language (XML) string, and the like. At this point a definition 804 may be inserted, additionally as a block-level element 814 or inline element under the conditions described elsewhere in this disclosure.

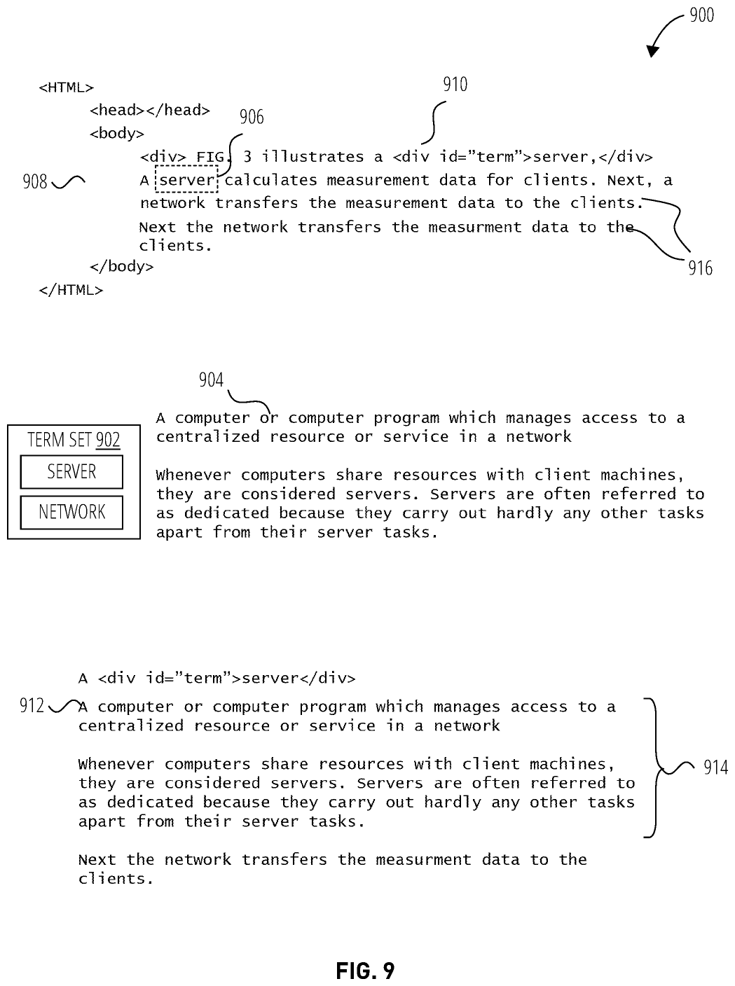

Referring to FIG. 9, an inline text insertion based on tagging identified text 900 is shown. This description follows closely to that explained above in FIG. 8 for a block-level element, differing in the placement—and often the format—of a definition following the term associated with the definition.

As in FIG. 8, each section 916 of a text document may be represented by a markup language string 908. In certain embodiments, a section 916 of a document may comprise ordered sections, initial sections, and/or predetermined sections of a document. In other embodiments, the text within a section may comprise one of a sentence, a paragraph, a detailed description section, a document, a set of documents, and a patent document. Each term as described above may be represented within the markup language string 908 by a unique tag 910. Also as in FIG. 8, a markup language uses unique tags in a text document allowing the instructions described above to cause the computer to search the text for the markup language string 908 for the term matching the unique tag 910.

In one embodiment, the definition 904 of a term from a term set 902 in the text in predetermined sections comprises a text format known in the art as an inline element 914, or formatting of an element immediately following a sentence. An inline element 914 does not typically comprise more than a phrase or sentence as embedding text in this fashion may cause text display difficulties, e.g., rearrangement of subsequent text. The advantage of using a text definition as an inline element, thereby creating an inline definition 912, includes allowing a reader to view a definition 904 associated with a term in a nearby context, e.g., without having to search for the definition 904 in some other location in the document. Just as with block-level element formatting, instructions cause the computer to merge the definition into text of the predetermined sections such that the definition is inserted at an insertion point 906. In the case of an inline element 914, however, the inline definition 912 inserts at the end of a paragraph that includes the term.

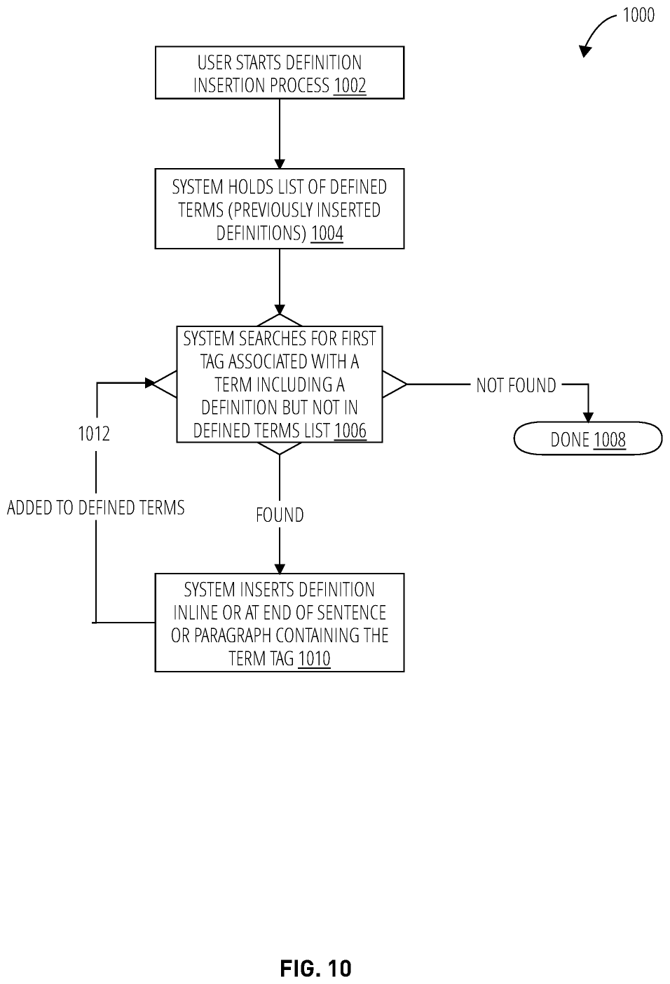

Referring to FIG. 10, a method for automatically inserting contextual definitions 1000 is illustrated. At block 1002, a user starts the definition insertion process for a document. At block 1004, the system holds a list of defined terms, or terms in the document for which a definition exists. Note this list may initially be empty until a definition is included for a term, e.g., changing it to a defined term. At decision block 1006, the system searches for the first tag associated with a term that includes a definition, but not yet part of the defined terms list. If no tag is found, at done block 1008 the process finishes. If a tag is found, at block 1010 the system inserts the definition either inline or at the end of sentence or paragraph containing the term tag. The term now becomes a defined term and the systems adds it to the list of defined terms. The iterative search 1012 process then cycles back to decision block 1006, where the system searches for the first tag in the document associated with a term that includes a definition, but not yet part of the defined terms list. The iterative search 1012 process continues until all terms with definitions are searched through the entire document, turning each into defined terms in turn.

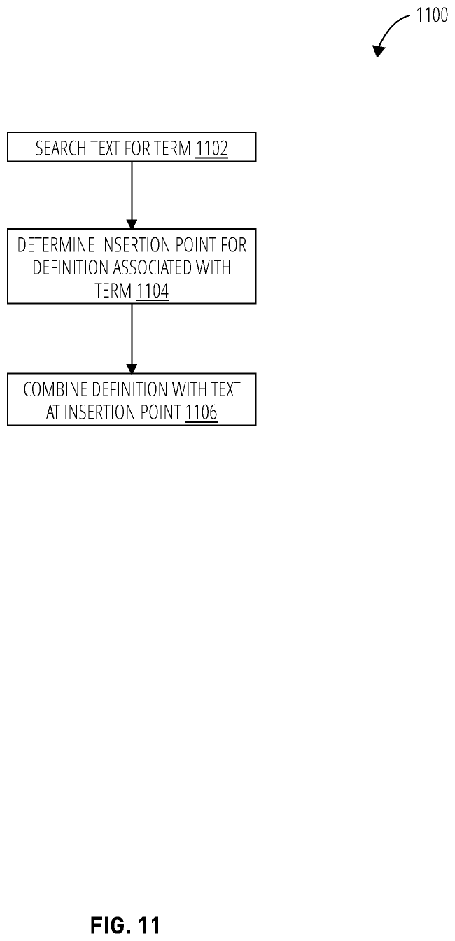

In FIG. 11, a routine 1100 is illustrated. In block 1102, a user searches text for a term. The text may be any written electronic work, for example a book, publication, article, document, patent document, and so forth. A term within the work may be any definable collection of letters and symbols (i.e., string) contained within the aforementioned text. Searching, in this instance, comprises matching the term with a second string until a match of the two strings occurs through an electronic process well known to those skilled in the art.

In block 1104, routine 1100 determines an insertion point for a definition associated with the term. Once a search for a term as described above completes, an insertion point is written into the electronic representation of the text where the definition may be inserted. The electronic representation of the text may be in a format well known to those skilled in the art for formatting documents, e.g., HTML, XML and similar standards for text display including tags. The insertion point written into the electronic representation of the text where the definition of the term may be inserted, may be any symbol or set of symbols easily distinguished from surrounding text, e.g., “###”.

In block 1106, routine 1100 combines the definition with the text at the insertion point. With the term identified and the insertion point inserted into the electronic representation of the text, the term definition combines with the text at the insertion point so the definition displays in an appropriate placement to the term when the electronic representation of the text is viewed through a software application able to parse the embedded tags.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure may be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described, or recited, as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, claims in this application that do not otherwise include the “means for” [performing a function] construct should not be interpreted under 35 U.S.0 § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

Herein, references to “one embodiment” or “an embodiment” do not necessarily refer to the same embodiment, although they may. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively, unless expressly limited to a single one or multiple ones. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list, unless expressly limited to one or the other. Any terms not expressly defined herein have their conventional meaning as commonly understood by those having skill in the relevant art(s).

Various logic functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” may be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

What is claimed is:

1. A method comprising:
searching text for a term;
determining an insertion point for a definition associated with the term; and
combining the definition with the text at the insertion point.

2. The method of claim 1, wherein determining the insertion point further comprises,
determining a first occurrence of the term within the text; and
defining the insertion point based on a position of the first occurrence of the term within the text.

3. The method of claim 1, wherein the text comprises one of a sentence, a paragraph, a detailed description section, a set of documents, a document, and a patent document.

4. The method of claim 1, wherein the term is associated with the definition by an author.

5. The method of claim 1, wherein the insertion point comprises an end of a sentence that comprises the term.

6. The method of claim 1, wherein the insertion point comprises an end of a paragraph that comprises the term.

7. The method of claim 1, wherein the definition comprises one or more paragraphs.

8. The method of claim 1, wherein determining the insertion point further comprises,
determining a term type for the term; and
defining the insertion point based on the term type.

9. The method of claim 1, wherein the text comprises one or more ordered sections and each section comprises one or more ordered subsections and the definition comprises a second term associated with a second definition, the method further comprising:
searching each subsection of the ordered sections, in order, for a first occurrence of the term;
inserting the definition at the insertion point resulting in an inserted definition, the insertion point comprising a position following a subsection comprising the first occurrence; and
searching the subsection comprising the inserted definition, in order, for the second term and inserting a definition for the second term after the inserted definition.

10. A computing apparatus, the computing apparatus comprising:
a processor; and
a memory storing instructions that, when executed by the processor, configure the apparatus to:
scan one or more ordered sections of a patent document for a term;
determine an insertion point for a definition associated with the term; and
insert the definition into the patent document at the insertion point.

11. The computing apparatus of claim 10, wherein:
each ordered section comprises an ordered set of paragraphs and the definition comprises a defined term; and
wherein the instructions further configure the computing apparatus to scan from a head of the patent document for the defined term after inserting the definition and to insert a defined term definition at a second insertion point, in response to identifying the defined term in the patent document at a position comprising a first occurrence for the defined term.

12. The computing apparatus of claim 10, wherein, each section is represented by a markup language string;
each term is represented by a unique tag; and
wherein scanning comprises searching the markup language string for a term in a set of defined terms matching the unique tag.

13. The computing apparatus of claim 10, wherein the term comprises a claim term.

14. A non-transitory computer-readable storage medium, the computer-readable storage medium including instructions that when executed by a computer, cause the computer to:
determine a document object model (DOM) for a patent document;
determine a term set, each term in the term set comprising an associated definition;
search predetermined sections of the DOM for the term in the term set; and
merge a definition into text of the predetermined sections in response to matching the term in the term set with the term in the text of the predetermined sections.

15. The non-transitory computer-readable storage medium of claim 14, wherein the instructions further cause the computer to remove the term from the term set and conduct an iterative search of each section of the predetermined sections, starting at an initial section, for each term in the term set.

16. The non-transitory computer-readable storage medium of claim 14, wherein instructions that cause the computer to search the predetermined sections of the DOM further comprise instructions to:
identify text in the predetermined sections of the DOM that matches text of a term in the term set; and
tag the identified text to uniquely associate the identified text with the term.

17. The non-transitory computer-readable storage medium of claim 14, wherein:
each predetermined section and each definition comprise a markup language string;
the definition further comprises a block-level element; and
wherein the instructions further cause the computer to merge the definition into the text of the predetermined sections such that the definition is inserted as a new paragraph following a paragraph that includes the term.

18. The non-transitory computer-readable storage medium of claim 14, wherein:
each predetermined section and each definition comprise a markup language string;
the definition further comprises an inline element; and
wherein the instructions further cause the computer to merge the definition into the text of the predetermined sections such that the definition is inserted at an end of a paragraph that includes the term.

19. The non-transitory computer-readable storage medium of claim 14, wherein the instructions further cause the computer to:
order the predetermined sections according to a document order for the patent document; and
to search the predetermined sections in order such that merging the definition into a section of the predetermined sections results in the definition following a first occurrence of the term in order from a top of the patent document to a bottom of the patent document.

20. The non-transitory computer-readable storage medium of claim 14, wherein the instructions that cause the computer to search predetermined sections of the DOM for the term in the term set further cause the computer to search the predetermined sections of the DOM for a first occurrence of the term.
